(19) United States
(12) Patent Application Publication
(10) Pub. No.: US 2011/0248161 A1
(43) Pub. Date: Oct. 13, 2011

(54) Multi-Turn Time-of-Flight Mass Spectrometer

(75) Inventors: Kengo Takeshita, Kyoto (JP); Hideaki Izumi, Osaka (JP)

(73) Assignee: SHIMADZU CORPORATION, Kyoto-shi, Kyoto (JP)

(21) Appl. No.: 13/122,382

(22) PCT Filed: Oct. 2, 2008
(86) PCT No.: PCT/JP2008/002771

§ 371 Date: Jun. 17, 2011

(51) Int. Cl. H01J 49/46

(52) U.S. Cl. 250/287

(57) ABSTRACT

The present invention aims at automatically obtaining a mass spectrum over a wide mass range with a high mass resolution, without the need of the complicated determination of the number of turns or other troublesome computations due to the overtaking of ions on a loop orbit. First, a mass analysis of a target sample is performed under conditions which ensure that the overtaking of ions does not occur, to obtain a mass spectrum with a low mass resolution (S1 and S2). One or more peaks appearing on the mass spectrum are extracted based on predetermined conditions, the mass ranges corresponding to the extracted peaks are determined, and the analysis conditions which ensure that the overtaking of ions does not occur are determined for each of the mass ranges (S3 and S4). Then, in accordance with the analysis conditions, ions within a restricted mass range are selected and ejected from the ion trap to be made to fly along the loop orbit, and mass spectra with a high mass resolution are obtained (S5 and S6). The mass spectrum with a low mass spectrum and the mass spectra with a high mass resolution are eventually combined to create a mass spectrum over a wide mass range (S8).

### TECHNICAL FIELD

The present invention relates to a multi-turn time-of-flight mass spectrometer in which ions originating from a sample are made to repeatedly fly along a closed loop orbit to separate and detect them in accordance with their mass (to be exact, their mass-to-charge ratio).

### BACKGROUND ART

A “Time-of-Flight Mass Spectrometer” (TOF-MS) is a type of device used for performing a mass analysis by measuring the time of flight required for each ion to travel a specific distance and converting the time of flight to the mass. This analysis is based on the principle that ions accelerated by a certain amount of energy will fly at different speeds corresponding to their mass, Accordingly, elongating the flight distance of ions is effective for enhancing the mass resolving power, However, the elongation of a flight distance along a straight line requires an enlargement of the device. Given this factor, Multi-Turn Time-of-Flight Mass Spectrometers (Multi-Turn TOF-MS) have been developed in which ions are made to repeatedly fly along a closed orbit such as a substantially circular shape, substantially elliptical shape, substantially “8” figure shape, or other shapes, in order to simultaneously achieve the elongation of the flight distance and the downsizing of the apparatus (refer to Patent Documents 1 and 2, and other documents). Another type of device developed for the same purpose is the multi-reflection time-of-flight mass analyzer, in which the aforementioned loop orbit is replaced by a reciprocative path in which a reflecting electric field is created to make ions fly back and forth multiple times and thereby elongate their flight distance. Although the multi-turn time-of-flight type and the multi-reflection time-of-flight type use different ion optical systems, they are essentially based on the same principle for improving the mass resolving power. Accordingly, in the context of the present description, the “multi-turn time-of-flight type” should be interpreted as inclusive of the “multi-reflection time-of-flight type.”

As previously described, a multi-turn time-of-flight mass spectrometer can achieve a high level of mass resolving power. However, it has a drawback due to the fact that the flight path of the ions is a closed orbit. That is, as the number of turns of the ions increases when they are made to fly along the closed orbit, an ion having a smaller mass and flying faster overtakes another ion having a larger mass and flying at a lower speed. If such an overtaking of the ions having different masses occurs, it is possible that some of the peaks observed on an obtained time-of-flight spectrum correspond to multiple ions that have undergone a different number of turns, i.e. traveled different flight distances. This means it is no longer ensured that the mass and the time of flight uniquely correspond, so that the time-of-flight spectrum cannot be directly converted to a mass spectrum.

Because of the aforementioned problem, in conventional multi-turn time-of-flight mass spectrometers, ions are selected in advance among the ions that originate from a sample generated in an ion source so that their mass is limited to a range where the aforementioned overtaking will not occur. The selected ions are made to fly along the loop orbit to undergone a predetermined number of turns and then be detected. Although a mass spectrum with a high mass resolution can be obtained with such a method, the range of the mass spectrum is significantly limited. This is contrary to the advantage of TOF-MSs that a mass spectrum with a relatively wide mass range can be obtained by one measurement.

Patent Document 3 and other documents propose a method for performing a data processing function in which the results obtained by performing a plurality of mass analyses of the same sample under different conditions are compared to deduce the number of turns of the peaks appearing on a mass spectrum. Although such a method is effective, the data processing will be inevitably complicated. Moreover, the deduction of the number of turns is difficult particularly when the number of components contained in the sample is large.

[Patent Document 1] JP-A 2006-228435

[Patent Document 2] JP-A 2008-27683

[Patent Document 3] JP-A 2005-116343

### DISCLOSURE OF THE INVENTION

### Problem to be Solved by the Invention

The present invention has been developed in view of the aforementioned problems and the objective thereof is to provide a multi-turn time-of-flight mass spectrometer capable of obtaining a mass spectrum with a high mass resolving power over a wide mass range, without performing a complicated processing of determining the number of turns or other troublesome operations.

### Means for Solving the Problem

To solve the aforementioned problem, the present invention provides a multi-turn time-of-flight mass spectrometer having: an ion source for ionizing a sample; an ion optical system for forming a loop orbit along which ions originating from the sample are made to fly repeatedly; and a detector for detecting ions which have flown along the loop orbit, including:

a) an ion selector for selecting ions so as to limit a range of a mass of ions which are made to fly along the loop orbit;

b) a first measurement mode performance controller for obtaining a mass spectrum of a sample to be analyzed, by performing a mass analysis of the sample in a first measurement mode in which ions are made to fly while bypassing the loop orbit or to fly along the loop orbit until they undergo a number of turns which ensures that an overtaking of the ions will not occur;

c) a peak extractor for collecting information of peaks appearing on the mass spectrum obtained in the first measurement mode to extract one or more peaks which satisfy predetermined conditions and for obtaining a mass range corresponding to each of the peaks;

d) a second measurement mode performance controller for setting, for each of the one or more mass ranges obtained by the peak extractor, conditions which ensure that an overtaking of ions included in the mass range will not occur to limit a mass of the ions originating from the sample to be analyzed, and then for performing a mass analysis or analyses; and e) a spectrum creator for combining one or more mass spectra obtained as a result of the mass analysis or analyses of one or more mass ranges by the second measurement mode performance controller to create a mass spectrum over a wide mass range including the one or more spectra.

The conditions for extracting peaks by the peak extractor are not particularly limited. For example, the following conditions may be used.
Any peak should be extracted if its m/z value at the center thereof (or at the center of gravity thereof) or its m/z value after a centroid process equals a value specified by the user or falls within a range specified by the user;
Any peak having a peak intensity exceeding a threshold specified by the user should be extracted;
A number of peaks specified by the user in descending order of peak intensity should be extracted;
A number of peaks specified by the user in ascending or descending order of m/z value should be extracted; or
Any peak having a peak width larger than a width specified by the user should be extracted.

It should be noted that these are mere examples of the applicable conditions, and two or more of these conditions may be combined.

Under the control by the first measurement mode performance controller, the flight distance of ions originating from the sample is relatively short, and therefore the mass resolution of the obtained mass spectrum is low. Accordingly, ions having approximate masses remain unresolved and appear as one peak with some width on the mass spectrum. Even in the case where many peaks appear on the mass spectrum with a low mass resolution, the number of peaks (or components) on which the user actually focuses his or her attention is limited. Given this factor, the peak extractor extracts, in accordance with predetermined conditions as previously described, one or more peaks as peaks to be analyzed with a high mass resolving power, and specifies a mass range for each peak. If n peaks (where n is an integer equal to or greater than one) are extracted, the number of the mass ranges is also n, and the n mass ranges do not overlap.

Subsequently, a mass analysis of the sample to be analyzed is performed under the control by the second measurement mode performance controller. In this mass analysis, for each of the n mass ranges, analysis conditions (in particular, the number of turns) are appropriately set so as to ensure that the overtaking of ions included in the mass range will not occur. Generally speaking, the narrower the mass range is, the more number of turns can be set, increasing the mass resolving power that much. In this manner, the ions originating from the sample to be analyzed are selected for each of the n mass ranges by the ion selector, and mass analyses are performed under predetermined conditions to obtain mass spectra. Under the control by the second measurement mode performance controller, n mass spectra with a high mass resolution are obtained. Since each of the mass ranges of these n mass spectra corresponds to each of the extracted peaks, the spectrum creator combines these n mass spectra to create one mass spectrum over a wide mass range.

Although the n mass spectra lack information on many mass regions, the intensity of these regions may be set at zero by assuming that no components of interest exist in these regions. Meanwhile, the mass spectrum obtained under the control by the first measurement mode performance controller includes the information on the aforementioned missing mass regions. Hence, the spectrum creator may combine one or more mass spectra with a high mass resolution obtained under the control by the second measurement mode performance controller and the mass spectrum with a low mass resolution obtained under the control by the first measurement mode performance controller to create a mass spectrum over a wide mass range. In this case, the resulting mass spectrum contains both the information with a high mass resolution for the components on which the user focuses attention and the information with a low mass resolution for other components. Therefore, for example, if a component that the user has not expected is contained in a sample to be analyzed, the information on the component is not discarded but can be provided to the user.

As an embodiment of the multi-turn time-of-flight spectrometer according to the present invention, the ion selector may be an ion trap for temporarily storing the ions originating from the sample in the ion source and for selectively ejecting ions within a predetermined mass range among the stored ions.

The ion trap may be either a linear ion trap or a three-dimensional quadrupole ion trap.

In the multi-turn time-of-flight spectrometer according to the present invention, it is preferable that the second measurement mode performance controller repeats the following operation as many times as the number of the aforementioned one or more mass ranges: temporarily storing the ions originating from the sample to be analyzed in the ion trap; selectively ejecting ions which are limited to be within each of the one or more mass ranges; making the ions fly along the loop orbit; and detecting the ions.

In this case, even if the mass analyses of two or more mass ranges are performed under the control by the second measurement mode performance controller, both the generation of ions in the ion source and the injection of the ions into the ion trap are required only once. Among the ions across a wide mass range (which depends on the sample to be analyzed) stored in the ion trap, only the ions included within the mass ranges are selected and ejected from the ion trap, and then made to fly along the loop orbit and mass analyzed. Therefore, even in the case where the number of extracted peaks is large, i.e. in the case where the number of mass ranges for which mass analyses are performed in the second measurement mode is large, only a small amount of sample is required to be ionized, so that there is no need to prepare a large amount of sample.

### EFFECTS OF THE INVENTION

With the multi-turn time-of-flight mass spectrometer according to the present invention, it is possible to obtain a mass spectrum over a wide mass range and with a high mass resolution for at least a component on which a user focuses attention, without performing a complicated data processing such as the determination of the number of turns of ions when the overtaking of ions occurs. In addition, by setting peak extraction conditions and/or other conditions in advance, an analysis can be automatically performed to obtain a final spectrum without the need of manual operation or judgment in the course of the analysis. As a result, the analysis operation can be more efficient.

### BRIEF DESCRIPTION OF THE DRAWINGS

FIG. 1 is a schematic configuration diagram of a multi-turn time-of-flight mass spectrometer according to an embodiment of the present invention.

FIG. 2 is a flowchart showing a procedure of the analysis operation of the multi-turn time-of-flight mass spectrometer of the present embodiment.

FIG. 3 is an explanation diagram for the analysis operation of the multi-turn time-of-flight mass spectrometer of the present embodiment.

FIG. 4 shows an example of a mass spectrum obtained in the multi-turn time-of-flight mass spectrometer of the present embodiment.

### EXPLANATION OF NUMERALS

1 . . . Ion Source
2 . . . Ion Transport Optical System
3 . . . Ion Trap
31 . . . Ring Electrode
32, 33 . . . End Cap Electrode
4 . . . Multi-Turn Ion Optical System
41 . . . Sector-Shaped Electrode Pair
42 . . . Loop Orbit
5 . . . Detector
6 . . . AID Converter
7 . . . Ion Transport Unit Voltage Applier
8 . . . Ion Trap (IT) Unit Voltage Applier
9 . . . Multi-Turn Time-of-Flight (MT-TOF) Unit Voltage Applier
10 . . . Personal Computer
11 . . . Controller
12 . . . Data Proceesor
121 . . . Spectrum Memory
122 . . . Peak Extractor
123 . . . Analysis Condition Determiner
124 . . . Combined Spectrum Creator
13 . . . Input Unit
14 . . . Display Unit

### BEST MODE FOR CARRYING OUT THE INVENTION

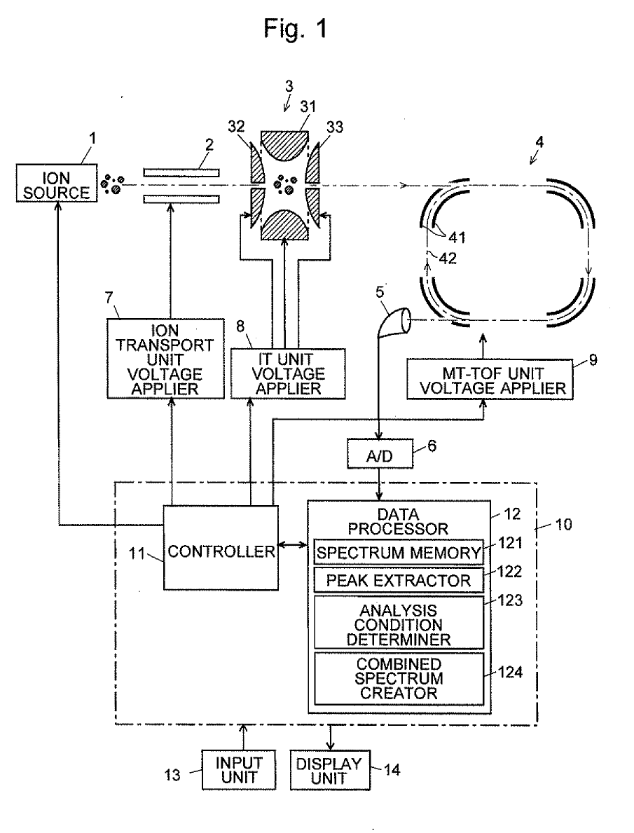

A multi-turn time-of-flight mass spectrometer according to an embodiment of the present invention will be described with reference to the attached figures. FIG. 1 is a schematic configuration diagram of the multi-turn time-of-flight mass spectrometer of the present embodiment.

An ion source 1, an ion transport optical system 2, an ion trap 3, a multi-turn ion optical system 4, and a detector 5 are provided in a vacuum chamber (not shown) evacuated by a vacuum pump.

The ion transport optical system 2, which is composed of a plurality (e.g. eight) of rod electrodes for example, sends ions into the subsequent stage, while suppressing the dispersion of the ions, by the action of the electric field formed by a voltage applied from an ion transport unit voltage applier 7.

The ion trap (which corresponds to the ion selector of the present invention) 3 is a three-dimensional quadrupole ion trap composed of one ring electrode 31 and two end cap electrodes 32 and 33. A radio-frequency voltage or a direct-current voltage is applied from an ion trap (IT) unit voltage applier 8 to each of the electrodes 31, 32, and 33,. In place of the three-dimensional quadrupole ion trap, a linear ion trap may be used.

The multi-turn ion optical system 4 includes a plurality of sector-shaped electrode pairs 41 and forms a loop orbit 42 by the action of sector-shaped electric fields generated by the voltage applied to the sector-shaped electrode pairs 41 from an MT-TOF unit voltage applier 9. The shape of the loop orbit 42 is not limited to this type of shape but can be any shape, e.g. a figure “8” shape.

The ion source 1 and each of the voltage appliers 7, 8, and 9 are controlled by a controller 11 (which corresponds to the first measurement mode performance controller and the second measurement mode performance controller in the present invention). The detection signal by the detector 5 is converted into digital data at predetermined sampling time intervals by an A/D converter 6, and the data are processed by a data processor 12. The data processor includes a spectrum memory 121, a peak extractor 122, an analysis condition determiner 123, a combined spectrum creator 124, and other units. The controller 11 and the data processor 12 perform a specific operation (which will be described later) by executing, for example, a dedicated control/process software program installed in a personal computer 10 as a hardware resource to which an input unit 13 and a display unit 14 are connected.

The basic mass analysis operation in the multi-turn time-of-flight mass spectrometer of the present embodiment will be briefly described.

Sample molecules are ionized in the ion source 1 and a variety of generated ions are sent via the ion transport optical system 2 into the ion trap 3 to be temporarily stored therein. After that, a predetermined initial energy is given to the stored ions in the ion trap 3 so that they are ejected almost collectively to start flying. That is, even in the case where ions are continuously generated in the ion source 1, it is possible to store ions generated in a certain period of time in the ion trap 3, and eject them in a pulsed fashion toward the multi-turn ion optical system 4. Since the ion trap 3 has a function of mass selection as is well known, it is possible to selectively eject ions in a specific mass range, in addition to collectively ejecting all the stored ions.

Ions which have started flying from the ion trap 3 as a starting point fly along the loop orbit 42 in the multi-turn ion optical system 4. After completing one or more turns along the loop orbit 42, the ions are deviated from the loop orbit 42 and reach the detector 5 to be detected. The length of the flight path of an ion after departing from the ion trap 3 until impinging on the detector 5 depends on the number of turns along the loop orbit 42. Therefore, the larger the number of turns is, the higher the mass resolving power becomes. The data processor 12 creates a time-of-flight spectrum by recording ion intensity data obtained from the detection signal on a time axis based on the point in time when ions depart from the ion trap 3 for example, and converts the time axis into a mass axis to create a mass spectrum.

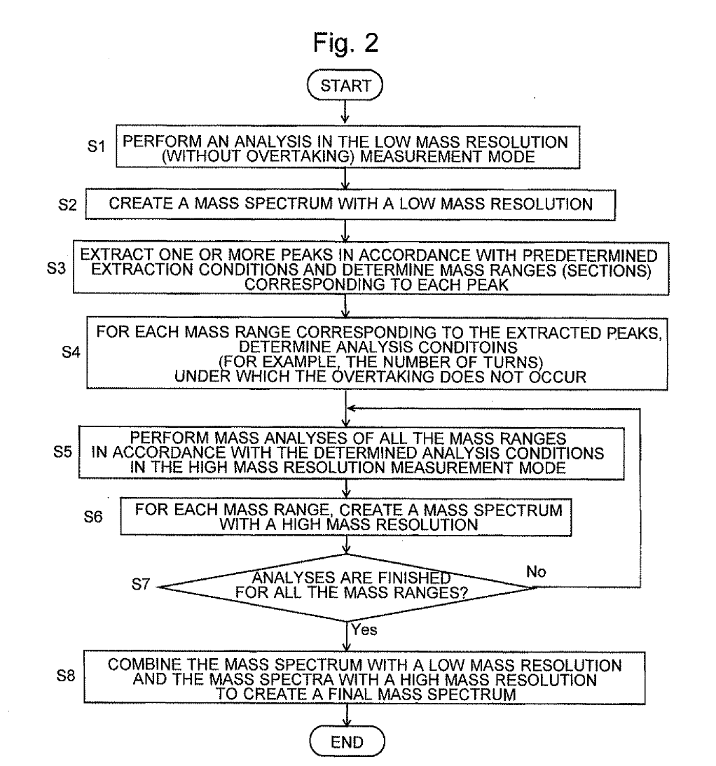

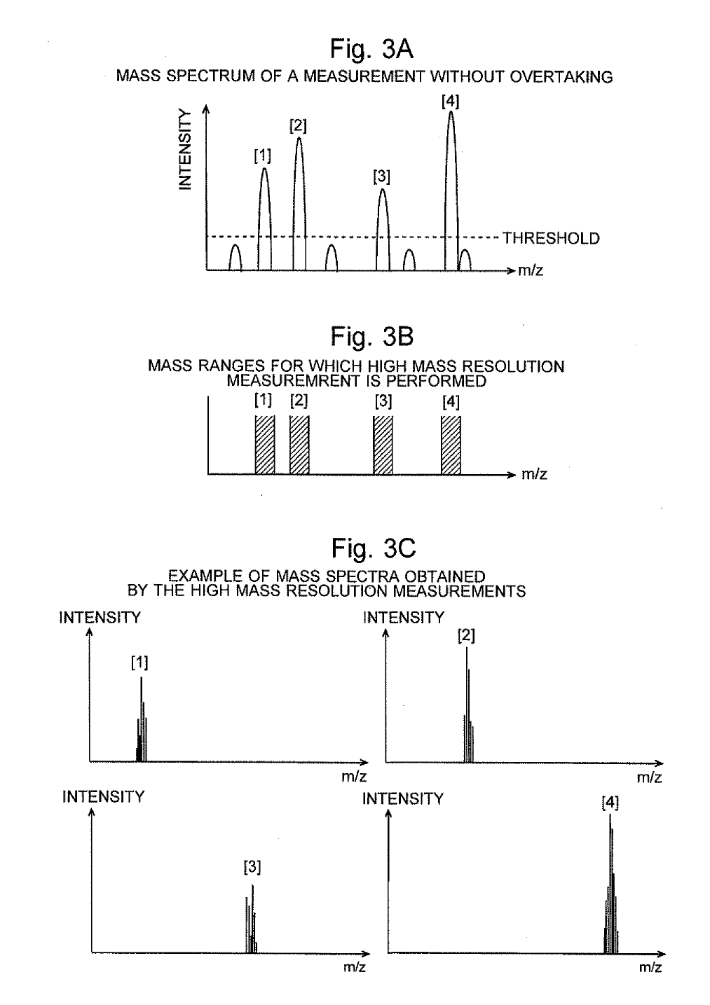

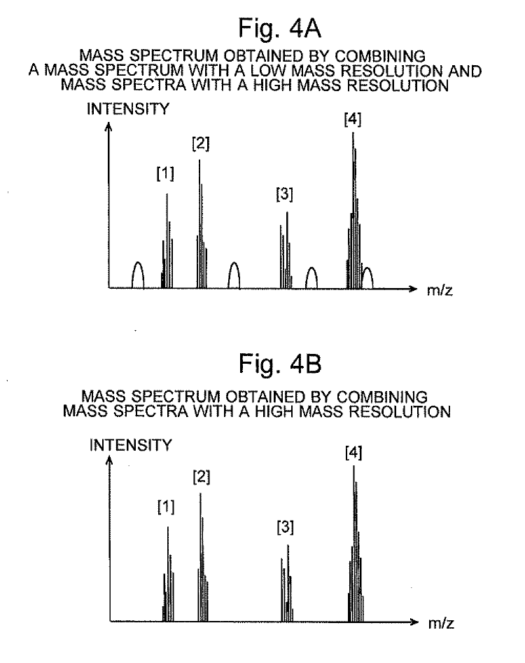

Next, the analysis operation characteristic of the multi-turn time-of-flight mass spectrometer of the present embodiment will be described with reference to FIGS. 2 through 4, FIG. 2 is a flowchart showing the procedure of this analysis operation, FIG. 3 is an explanation diagram for the analysis operation, and FIG. 4 shows an example of a finally obtained mass spectrum.

When an automatic analysis is initiated, the controller 11 controls each unit so as to perform an analysis in a low mass resolution measurement mode (which corresponds to the first measurement mode in the present invention), as the first measurement of a sample to be analyzed (Step S1). In this operation, the IT unit voltage applier 8 applies a voltage to each of the electrodes 31, 32, and 33 so as to eject all the temporarily stored ions from the ion trap 3 in a pulsed fashion, i.e. without performing mass selection. Meanwhile, the MT-TOF unit voltage applier 9 applies a voltage to the sector-shaped electrode pairs 41 so that ions on the loop orbit 42 will enter the detector 5 before completing the first turn. This ensures that the overtaking of ions ejected from the ion trap 3 do not occur during their flight regardless of their mass.

In the case where the mass range of the ions ejected from the ion trap 3 is previously known and it is certain that the overtaking of ions will not occur after the ions undergo a plurality of turns along the loop orbit 42, the ions may be made to complete that number of turns and then introduced into the detector 5.

The data processor 12 creates a mass spectrum based on the detection signal obtained in the low mass resolution measurement mode (Step S2). For example, consider the case where a mass spectrum as shown in FIG. 3A has been obtained. Since the overtaking of ions did not occur during their flight as previously described, the flight distance of all the ions is the same. Hence, this mass spectrum is equivalent to that obtained in a general linear time-of-flight mass spectrometer or a reflectron time-of-flight mass spectrometer. However, the mass resolving power is low due to the short flight distance, so that the peaks of ions with approximate masses remain unresolved and appear as one peak having some width. This mass spectrum is stored in the spectrum memory 121.

Next, the peak extractor 122 in the data processor 12 extracts peaks on the aforementioned mass spectrum in accordance with the previously set peak-extraction conditions and determines the mass range corresponding to the extracted peaks (Step S3). The peak extraction conditions are specified by the user through the input unit 13 in advance of the initiation of the automatic analysis. The user appropriately sets the conditions based on the purpose of the analysis and/or previously known information in order to analyze the component of interest. For example, one of the following conditions can be set:

(1) Any peak should be extracted if its mass at the center thereof (or at the center of gravity thereof) or its mass after a centroid process equals a value specified by the user or falls within a range specified by the user;

(2) Any peak having a peak intensity exceeding a specified threshold should be extracted;

(3) Only a specified number of peaks in descending order of peak intensity should be extracted;

(4) Only a specified number of peaks in descending or ascending order of mass should be extracted; or

(5) Any peak having a peak width larger than a specified width should be extracted.

For example, consider the case where the aforementioned extraction condition (2) is set. If the threshold of the peak intensity is set as shown in FIG. 3A, four peaks indicated with [N] (where N=1, 2, 3, or 4) are extracted. After the peaks are extracted in this manner, the peak extractor 122 determines the mass range (i.e. the lower mass side limit and the higher mass side limit) for each of the extracted peaks. In this embodiment, four different mass ranges, each corresponding to [N], are determined as shown in FIG. 3B.

Next, with respect to each of the mass ranges, the analysis condition determiner 123 computes the largest possible number of turns within a range where it is ensured that the overtaking of ions does not occur while the ions are made to fly along the loop orbit 42 (Step S4). This step can be performed based on a theoretical computation, but computing on the basis of data obtained by an exploratory experiment is more secure. The four mass ranges and the number of turns for each of these mass ranges are sent to the controller 11 as the analysis conditions. Instead of the number of turns, the period of time for making the ions fly along the loop orbit 42 may be used.

The controller 11 controls each unit so as to perform an analysis in a high mass resolution measurement mode (which corresponds to the second measurement mode in the present invention), as the second measurement of the sample to be analyzed (Step S5). The ions originating from the sample to be analyzed which are generated in the ion source 1 are temporarily stored in the ion trap 3. After that, the IT unit voltage applier 8 applies a voltage to each of the electrodes 31, 32, and 33 so that only the ions included in the mass range corresponding to the peak [1] among the ions temporarily stored in the ion trap 3 are ejected from the ion trap in a pulsed fashion. Ions not included in that mass range are left in the ion trap 3.

The MT-TOF unit voltage applier 9 applies a voltage to the sector-shaped electrode pairs 41 so that ions on the loop orbit 42 undergo the number of turns which has been set as the aforementioned analysis conditions. For example, if the number of turns of the ions for the mass range corresponding to the peak [1] has been set at 100, the MT-TOF unit voltage applier 9 controls the timing of applying the voltage so that the ions are deviated from the loop orbit 42 after completing 100 turns. Unless a detector for nondestructively detecting ions is provided, the actual position of the ions in the flight path cannot be detected. Hence, actually, the timing when the ions are deviated from the loop orbit 42 is determined based on the period of time of the flight.

The data processor 12 creates a mass spectrum based on the detection signal obtained in the high mass resolution measurement mode (Step S5). For example, consider the case where a mass spectrum as shown in FIG. 3C has been obtained as a mass spectrum corresponding to the mass range of the peak [1]. In this case, the flight distance is longer and therefore a higher mass resolving power is obtained: one peak in FIG. 3A has been resolved into a plurality of peaks in FIG. 3C. However, the mass range is considerably narrow. This mass spectrum with a high mass resolution is also stored in the spectrum memory 121.

Subsequently, the controller 11 determines whether or not the mass analyses have been performed for all the mass ranges that were set as the analysis conditions (Step S7). In the case where one or more analyses are left to be performed, the process returns to Step S5. At the stage where only the analysis corresponding to the mass range of the peak [1] has been finished, the process returns to Step S5, and the IT unit voltage applier 8 applies a voltage to each of the electrodes 31, 32, and 33 so that only the ions included in the mass range corresponding to the peak [2] among the ions remaining in the ion trap 3 and selectively ejected from the ion trap in a pulsed fashion. Then, a mass analysis as previously described is performed for these ejected ions in the high mass resolution measurement mode to obtain a mass spectrum, which is stored in the spectrum memory 121.

By repeating Steps S5 and S6, mass spectra corresponding to all the mass ranges [1] through [4] are obtained as shown in FIG. 3C. In each mass spectrum, peaks at approximate masses are sufficiently separated.

After all the mass analyses are completed, the combined spectrum creator 124 reads out the stored mass spectra from the spectrum memory 121, combines them to create a mass spectrum over a wide mass range, and shows the mass spectrum on the window of the display unit 14 (Step S8). In this step, there are two possible methods to combine the mass spectra.

One method is to combine only the mass spectra with a high mass resolution, By combining different mass spectra shown in FIG. 3C, a mass spectrum as shown in FIG. 4B can be obtained. In this case, although all the peaks appearing on the mass spectrum are obtained by the high mass resolution measurements, the mass spectrum lacks information on the mass ranges for which the high mass resolution measurement has not been performed.

The other method is to combine the mass spectrum with a low mass resolution which is obtained in Step S2 and the mass spectra with a high mass resolution which are obtained in Step S6. That is, a mass spectrum is combined using the high-resolution mass spectra for the mass ranges for which a high mass resolution measurement has been performed, and the low-resolution mass spectrum for the other mass ranges. By combining the mass spectra shown in FIG. 3A and FIG. 3C, a mass spectrum as shown in FIG. 4A can be obtained. In this case, the peaks obtained by high mass resolution measurements and the peaks obtained by a low mass resolution measurement are mixed on the mass spectrum. Thus, the information on the mass areas for which a high mass resolution measurement has not performed can also be reflected in the mass spectrum.

As previously described, with the multi-turn time-of-flight mass spectrometer of the present embodiment, it is possible to automatically obtain a mass spectrum over a wide mass range with a high mass resolving power.

It should be noted that the embodiment described thus far is merely an example of the present invention, and it is evident that any modification, adjustment, or addition appropriately made within the spirit of the present invention is also included in the scope of the claims of the present application.

1. A multi-turn time-of-flight mass spectrometer including: an ion source for ionizing a sample; an ion optical system for forming a loop orbit along which ions originating from the sample are made to fly repeatedly; and a detector for detecting ions which have flown along the loop orbit, comprising:
a) an ion selector for selecting ions so as to limit a range of a mass of ions which are made to fly along the loop orbit;
b) a first measurement mode performance controller for obtaining a mass spectrum of a sample to be analyzed, by performing a mass analysis of the sample in a first measurement mode in which ions are made to fly while bypassing the loop orbit or to fly along the loop orbit until they undergo a number of turns which ensures that an overtaking of the ions will not occur;
c) a peak extractor for collecting information of peaks appearing on the mass spectrum obtained in the first measurement mode to extract one or more peaks which satisfy predetermined conditions and for obtaining a mass range corresponding to each of the peaks;
d) a second measurement mode performance controller for setting, for each of the one or more mass ranges obtained by the peak extractor, conditions which ensure that an overtaking of ions included in the mass range will not occur to limit a mass of the ions originating from the sample to be analyzed, and then for performing a mass analysis or analyses; and
e) a spectrum creator for combining one or more mass spectra obtained as a result of the mass analysis or analyses of one or more mass ranges by the second measurement mode performance controller to create a mass spectrum over a wide mass range including the one or more spectra.

2. The multi-turn time-of-flight mass spectrometer according to claim 1, wherein:
the ion selector is an ion trap for temporarily storing the ions originating from the sample in the ion source and for selectively ejecting ions within a predetermined mass range among the stored ions.

3. The multi-turn time-of-flight mass spectrometer according to claim 2, wherein:
the second measurement mode performance controller repeats the following operation as many times as a number of the one or more mass ranges: temporarily storing the ions originating from the sample to be analyzed in the ion trap and then selectively ejecting ions which are limited to be within each of the one or more mass ranges, making the ions fly along the loop orbit, and detecting the ions.

4. The multi-turn time-of-flight mass spectrometer according to claim 1, wherein:
the spectrum creator combines one or more mass spectra with a high mass resolution obtained under a control by the second measurement mode performance controller and a mass spectrum with a low mass resolution obtained under a control by the first measurement mode performance controller to create a mass spectrum over a wide mass range.
